(19) United States
(12) Patent Application Publication
(10) Pub. No.: US 2010/0278978 A1
(43) Pub. Date: Nov. 4, 2010

(54) Reduced Milk Fat Non-standardized Milk Chocolate (Milk Fat Free/Low Milk fat) and Standardized Reduced Milk Fat Milk Chocolate with Improved Health Characteristics

(76) Inventor: Gary Ervin, Naples, FL (US)

Correspondence Address: Gary Ervin, 3431 8th Ave. SE, Naples, FL, 34117, US

(21) Appl. No.: 12/765,768

(22) Filed: Apr. 22, 2010

Related U.S. Application Data
(60) Provisional application No. 61/172,167, filed on Apr. 23, 2009.

(51) Int. Cl. A23G 1/32; A23G 1/54

(52) U.S. Cl. 426/72; 426/541; 426/74; 426/519; 426/512; 426/306

(57) ABSTRACT

A reduced milk fat, reduced sugar, improved health characteristic, higher antioxidant content, improved taste, texture, melt, and creaminess non-standardized milk chocolate that can have a milk fat content of 0% to 8% and is blended with a standardized chocolate, an edible oil blend, 100% Cocoa Powder, Confectionery Sugar, Cocoa Seed Butter Crystals, and synergistic antioxidant flavor blend including; Virgin Coconut Oil, Vanilla Powder, Blackberry, and Acai Berry. A standardized milk chocolate product with 3.69% or higher milk fat that has improved health characteristics , higher antioxidant content, improved taste, texture, melt, and creaminess from a synergistic antioxidant flavor blend including; Virgin Coconut Oil, Vanilla Powder, Blackberry, and Acai Berry. The ingredients are in specific amounts and ratios such that they can be easily incorporated into the compositions without adversely affecting the stability or feel, and actually improve taste, texture, melt, and creaminess as well as improve health characteristics of the compositions. The compositions can be manufactured and sold in any format that current chocolate confectionery products are sold in including; squares, tablet bars, molded shapes, as coatings or as enrobing material, or as ingredients in foods that have chocolate or chocolate compositions in them, etc. Additionally the process for preparing such compositions is provided.

The present application claims the benefit of U.S. Provisional Application Ser. No. 61/172,167 filed on Apr. 23, 2009.

### BACKGROUND OF THE INVENTION

1. Field of the Invention

This invention relates generally to ingestible confectionery compositions based on a non-standardized or standardized composition milk chocolate primary component, particularly to milk chocolate and low milk fat milk chocolate compositions that exhibit have improved health characteristics, higher antioxidant content, lower milk fat, lower sugar content, unique taste profile created by the synergistic reaction of the antioxidant blend which produces an improved taste, texture, melt, and creaminess in the formulation. It is widely understood that chocolate per se contains a relatively high level of antioxidants vs. most foods and thus these antioxidants are proven to provide certain heart healthy attributes. It is also well known that high cocoa dark chocolate provides higher levels of these antioxidants than does milk chocolate. This is due to the fact that the antioxidants in chocolate are derived from cocoa solids, which are present in both dark and milk chocolate, and since milk chocolate has a lower level of cocoa solids than dark chocolate it therefore has lower levels of antioxidants. This is unfortunate from a health benefit perspective because consumers worldwide prefer milk chocolate over dark chocolate based on a taste preference for milk chocolate.

Several aspects of milk chocolate make it less healthy and not as good for you as dark chocolate especially high cocoa dark chocolate.

Several aspects of milk chocolate make it less healthy than high cocoa dark chocolate:
1) Many producers add high levels of milk fat to chocolate formulations to create the rich and creamy taste and texture that consumer's love. Some brands such as Cadbury and Lindt offer milk chocolate formulations with as high as 20% milk fat by volume. Most global brands of milk chocolate have 8% or higher milk fat by volume. This high level of milk fat adds unhealthy animal saturated fat to these formulation which produce negative health ramifications including contributing to heart disease, cardiovascular disease, and obesity.
2) Most producers utilize as little chocolate liquor as possible in their formulations because it is a relatively costly component of chocolate formulas. The result is that the beneficial antioxidants found in chocolate liquor are relatively low in most milk chocolate products globally.
3) Chocolate liquor is also minimized in chocolate formulations as it contributes a bitter taste profile. To address this bitterness, many producers use chocolate liquor processed with alkali because it offers a mellower taste. Unfortunately when chocolate liquor is processed with alkali it loses 40% to 90% of its beneficial antioxidant content.
4) Many producers add high levels of sugar to their milk chocolate formulations to address bitterness and provide a sweet flavor profile. As a result many brands of milk chocolate have over 50% sugar in their formulas. High levels of refined sugar in the daily diet has been linked to heart disease, diabetes, and other chronic health conditions.

Our invention addresses all of the negative health aspects of milk chocolate addressed above. The present invention improves the health characteristics of milk chocolate and improves taste, texture, melt, and creaminess that consumer's desire in a high quality milk chocolate or non-standardized milk chocolate composition. Through years of research, development and experimentation we have created compositions contained within this invention which correct:

a) Excessively high milk fat content, with low levels or zero levels of milk fat

Our invention replaces high levels of milk fat in the composition with a healthier blend of edible oils, 100% Cocoa powder, confectionery sugar, and an antioxidant blend flavor profile that create a similar rich taste, texture, melt, and creaminess similar to that achieved through the addition of milk fat in standard milk chocolate formulations.

b) Low levels of chocolate liquor, with higher levels of chocolate liquor used and 100% Cocoa Powder added within certain embodiments of the invention

Our invention can use higher levels of chocolate liquor and in the non-standardized milk chocolate compositions add 100% Cocoa powder, the highest antioxidant content part of the Cocoa bean, to increase the beneficial antioxidant content from Cocoa solids while maintaining similar taste, texture, melt, and creaminess similar to that achieved in standard milk chocolate.

c) Elimination of chocolate liquors processed with alkali, to retain existing antioxidants in such liquor

We have discovered through research and development methods to mellow the bitterness in chocolate liquor versus processing the chocolate liquor with alkali. Thus, we can preserve the health characteristics of the chocolate liquor (antioxidant content) and actually raise the level of cocoa solids in our formulations, thus increasing antioxidant levels while maintaining the taste profile that consumers desire in a milk chocolate product.

d) Substantial reduction of the level of sugar present in our milk chocolate formulations.

Our non-standardized milk chocolate compositions and standardized milk chocolate compositions displace sugar within the composition resulting in non-standardized milk chocolate and standardized milk chocolate compositions with improved taste and up to 50% less sugar.

e) Better balance of dietary fats in our non-standardized milk chocolate compositions.

Our non-standardized milk chocolate compositions displace saturated milk fat and sugar within the composition with an edible oil blend that results in a better balance between the saturated, monounsaturated, and polyunsaturated fats. In certain embodiments of this invention we can add beneficial Omega 6 linoleic and Omega 3 alpha linolenic oils to the non-standardized milk chocolate compositions that improves the health characteristics of the products.

2. Description of Related Art

The most popular chocolate or chocolate confections consumed in the United States are in the form of sweet chocolate or milk chocolate. 80% of the chocolate purchased in the US is milk chocolate and globally milk chocolate also dominates the market place. Milk chocolate is a confection which contains nonfat milk solids, milk fat, chocolate liquor, a nutritive carbohydrate sweetener, cocoa butter and may include other optional ingredients such as emulsifiers and flavorings and other additives. Milk chocolate contains a low level of chocolate liquor, usually around 10%, from 3.69% to up to 20% milk fat, and sugar is the dominant ingredient in all current brands of milk chocolate. This high sugar and milk fat content in milk chocolate are proven to have negative health consequences that can increase the risk of cardiovascular disease, coronary heart disease, and diabetes. The low level of chocolate liquor in milk chocolate makes milk chocolate a low antioxidant source versus other types of chocolate forms.

The composition of milk chocolate is defined by regulations in many countries, such that there may be minimum required levels of dry cocoa solids, dry milk solids, dry nonfat cocoa solids, milk fat and total fat for chocolate. For example, in the United States, milk chocolate must contain at least 3.69% milk fat, 12% milk solids and not less than 10% chocolate liquor according to the standard of identity created by the FDA. It is believed that the type of milk solids used is influential in determining the flavor of the end product.

For example, U.S. Pat. No. 6,635,303 to Youcheff, et al. discloses powdered milk solids having a free fatty acid profile which can be used to prepare milk chocolate. The flavor profile of the product disclosed by Youcheff, et al. has been described as cheesy, soured and with a “soapy” character. The unique flavor is achieved through use of a powdered milk solid having a free fatty acid profile wherein the weight ratio of butyric acid (C4) to myristic acid (C14) is equal to or less than 1:2, e.g., 1:10,000, preferably 1:25 to 1:100 and most preferably 1:3 to 1:6. Youcheff, et al. allows ranges of 1% to 40% of the treated milk solids in combination with 0-30% of non-fat milk solids and 1-10% of milk fat, but does not disclose or suggest the use of relatively high amounts of milk solids. While Youcheff, et al. discloses having certain ranges of low fat milk chocolate, this process is done by utilizing lower fat sources of milk in the preparation of the milk chocolate. The present invention utilizes the inclusion of an antioxidant blend consisting of virgin coconut oil, vanilla powder and blackberry powder and within certain embodiments of the invention Acai berry extract that creates a flavor in the non-standardized and standardized milk chocolate compositions that gives the compositions improved taste, texture, melt, and creaminess, improved health characteristics, higher antioxidant content and less sugar versus standard milk chocolate. Our non-standardized milk chocolate compositions utilize an additional novel combination of ingredients including edible oils high in unsaturated fats, 100% cocoa powder, and confectionery sugar to create an even more improved health characteristic, higher antioxidant content, lower sugar composition versus regular milk chocolate. In certain embodiments of this non-standardized milk chocolate the milk fat can be reduced to as low as 0%, up to 50% less sugar, an improved balance of saturated, monounsaturated and polyunsaturated fats, great tasting, good texture, good melt and creaminess product versus regular milk chocolate.

U.S. Provisional Pat. No. 20070082116 to Sanders; Nigel Hugh discloses a milk chocolate with high milk solids. This invention suggests increasing milk solids in milk chocolate to achieve an improved nutritional value. While increasing the milk solids would give the consumer more of certain nutrients Sanders; Nigel Hugh still have high levels of milk fat in their invention and state milk fat levels would be between 5% and 8%. This milk fat content is still very high relative to established dietary guidelines and the medical community would suggest that one could obtain the nutritional benefits of milk solids in a wide range of healthier food forms including; skim milk or low fat milk; low fat or fat free ice cream, low fat or fat free yogurt, etc. without the negative health consequences associated with high levels of milk fat. Our invention improves the health characteristics of milk chocolate through the addition of an antioxidant flavor profile to our compositions and especially in our non-standardized milk chocolate compositions that lowers the milk fat content substantially and adds beneficial essential fatty acids to the compositions. High levels of milk fat in standard formulations of milk chocolate are a serious health concern and the Sanders; Nigel Hugh invention doesn't address this problem. Within certain embodiments of our invention we are able to create great tasting non-standardized milk chocolate compositions with 0% milk fat that delivers rich and creamy taste, texture, and melt similar to regular milk chocolate. If consumers can be persuaded to switch from current milk chocolate formulations to formulations created within this invention with its improved health characteristics, higher antioxidant content, less sugar, and significantly less milk fat, then the negative health issues related to current milk chocolate consumption could be significantly reduced. We believe that our inventions attendant improvements in taste, texture, melt, and creaminess vs. current milk chocolate formulations will help support such conversions. U.S. Pat. No. 6,143,350 to Dubberke; Karin discloses a reduced fat chocolate specifically a reduced fat milk chocolate. This invention creates milk chocolate with a total fat content of 27% or less. While this invention does lower the level of fat in the cocoa it doesn't lower the level of milk fat in the compositions and the invention states the milk fat level would be 3% to 7% by volume.

Chocolate used in foods in the United States is subject to a standard of identity established by the U.S. Food and Drug Administration (FDA) under the Federal Food, Drug and Cosmetic Act. The U.S. definitions and standards for the various types of chocolate are well established. Non-standardized chocolates are those chocolates which have compositions which fall outside the specified ranges of the standardized chocolates. Our invention can create either a standardized milk chocolate or a non-standardized milk chocolate composition that has substantially improved health characteristics, higher antioxidant content, less sugar, and great taste, texture, melt, and creaminess that consumer's desire in a milk chocolate composition. These non-standardized milk chocolate compositions can have from 0% to higher milk fat content, up to 50% less sugar, and can have addition of beneficial Omega 3 and Omega 6 essential fatty acids that are devoid currently in standard milk chocolate compositions.

As a confection, chocolate can take the form of solid pieces of chocolate, such as bars or novelty shapes, and can also be incorporated as a component of other, more complex confections where chocolate is combined with and generally coats other foods such as caramel, nougat, fruit pieces, nuts, wafers or the like. Other complex confections result from surrounding with chocolate soft inclusions such as cordial cherries or peanut butter. Other complex confections result from coating ice cream or other frozen or refrigerated desserts with chocolate. Generally chocolate used to coat or surround foods must be more fluid than chocolates used for plain chocolate solid bars or novelty shapes.

The process of coating chocolate onto a food is known as enrobing. Enrobing is accomplished when the chocolate is in a fluid state and a proper viscosity must be maintained in order to produce a satisfactory coated product. Chocolate can also be molded. By molding, it is meant that chocolate, either plain or mixed with nuts, raisins, crisped rice and the like is deposited in molds, allowed to cool and hardened into solid pieces and then removed from the mould. Chocolate molded into plain chocolate pieces generally can be somewhat more viscous than coating chocolates since the chocolate can be vibrated into a mould over a longer period of time than allowed in enrobing. However, chocolate molded with food inclusions generally must be as fluid as coating chocolates.

Much work has been done to create low fat or reduced fat standardized chocolate or non-standardized chocolate compositions. U.S. Pat. No. 5,464,649 to St. John, et. al. discloses a low fat chocolate confection that can be made with as low as 25% total fat having flow properties suitable for molding, extruding or enrobing operations. It was initially thought that low fat was the most important aspect of our diet that contributes to improved health for the consumer. In the 1980's the FDA set up its food labeling guidelines suggesting that “low fat” was important in the diet to reduce the risk of coronary heart disease and to improve consumer's health. Through continued scientific study it has now been established that it isn't the amount of fat in the diet that is the critical aspect for reducing health related issues like; coronary heart disease, diabetes, obesity, and other health issues, but rather the types and balance of fats included in the diet.

During the 80's and 90's food producers created a wide array of foods and confections that qualify as “low fat” based on the old medical science and the belief that in order to improve the consumer's health low fat foods were important. As seen in the link below the 2005 USDA Dietary Guidelines now suggests under its fat recommendations that consumers should reduce the amount of saturated fat in the diet and replace it with unsaturated fatty acids like monounsaturated and polyunsaturated fats. Consensus in the medical industry now has proven through clinical research and food studies that the consumer actually needs to get more fat in the daily diet not less fat. The unsaturated fats, especially monounsaturated and polyunsaturated fats in foods are now known to prevent diseases like; cardiovascular disease and coronary heart disease.

http://www.health.gov/DIETARYGUIDELINES/dga2005/document/html/chapter6.htm

The link below discusses the Harvard School of Public Health run Nurse's health study, the largest food study ever created to examine how certain fats affect consumer's long term health. The study concludes that consumers need to get more unsaturated fats and less saturated fats in their diets. The current invention creates standardized milk chocolate with lower milk fat levels and non-standardized milk chocolate compositions that have new structures which can reduce the milk fat content down to about 0% while balancing the saturated, monounsaturated and polyunsaturated fats within the milk chocolate and in some embodiments can add essential fatty acids Omega 6 and Omega 3 ALA's.

http://www.hsph.harvard.edu/nutrionsource/what-should-you-eat/fats-full-story/index.html

This was the largest study ever undertaken that examined the effect of reducing saturated fats and replacing them with unsaturated fats including monounsaturated and polyunsaturated fats. The study concluded that many of the major health issues facing consumers can be directly affected by the consumption of too much of the bad saturated fats including milk fat, partially hydrogenated, fully hydrogenated, and Trans fats. The study examined the effect increasing the amount of the healthier monounsaturated and polyunsaturated fats had on reducing the risks of developing these chronic health conditions. The study concluded that certain saturated fats are better and even have some health benefits compared to other saturated fats. The study showed that animal saturated fats have the largest negative effect on health and that saturated fats contained in cocoa butter and coconut oil actually have the lowest negative effect on health and actually have some positive health characteristics. Embodiments of our invention can create non-standardized milk chocolate compositions that deliver the same taste, texture, melt, and creaminess that consumer's desire in a milk chocolate while giving the consumer a healthier more balanced fat nutritional structure product.

### SUMMARY OF THE INVENTION

It is, therefore, an object of this invention to provide a great tasting improved health characteristic, higher antioxidant, lower milk fat content, lower sugar, standardized milk chocolate or non-standardized milk chocolate compositions. These milk chocolate compositions can be made as a standardized milk chocolate or as a milk chocolate composition that uses milk chocolate as the base for the non-standardized milk chocolate composition. It is another object of the present invention to create compositions that improve the taste, texture, melt, and creaminess of milk chocolate without the necessity of adding high levels of milk fat, processing the chocolate liquor with alkali, adding exorbitant amounts of sugar that all are used to improve the taste of milk chocolate at the expense of reducing the health benefits. It is another object of the present invention to improve the health characteristics of milk chocolate by creating standardized milk chocolate compositions that can have lower milk fat content, higher antioxidant content, and lower sugar versus regular milk chocolate. Another embodiment of this invention is to create a great tasting non-standardized milk chocolate with 25% to 75% less milk fat versus regular milk chocolate and up to 100% less milk fat (based on an industry average of 8% milk fat) with a great taste, texture, melt and creaminess versus regular milk chocolate. These new characteristics of a standardized milk chocolate composition or a non-standardized milk chocolate composition are created using novel combinations of antioxidant rich components and edible oils as well as a double blending process that creates a low milk fat non-standardized milk chocolate with the same taste, texture, melt, and creaminess that consumers love in a milk chocolate product.

It is another object of the present invention to create compositions of standardized milk chocolate that contains improved health characteristic ingredients like; virgin coconut oil, vanilla powder, blackberry powder, and Acai berry extract as flavor components that improve the taste, texture, melt, and creaminess of the product. Most major brands of milk chocolate use the current methods available to try and create a better tasting milk chocolate including; adding high levels of milk fat to try and improve the taste, texture, and melt or the brands, adding chocolate liquor processed with alkali to reduce the bitterness and make the aftertaste of the product more mellow, and adding high levels of sugar to make the product better tasting. Milka's Alpine milk is an example of a milk chocolate that adds significant amounts of milk and milk fat to its product in order to improve the taste, texture, and melt of the product. Cadbury's Dairy Milk is another example of a milk chocolate product with an extremely high level of milk fat. The Milka Alpine milk and Cadbury's Dairy Milk each have milk fat contents of 20% or above. Dove Silky Smooth milk chocolate is an example of a milk chocolate that uses cocoa processed with alkali. The processing with alkali reduces the antioxidant content of the chocolate liquor within the milk chocolate while creating a mellow, less bitter taste. Many global milk chocolate brands use extremely high levels of sugar. Hershey's milk chocolate is 56% sugar.

Most consumers believe that milk chocolate offers some health benefits because of the presence of cocoa solids in the milk chocolate. However, milk chocolate requires only 10% chocolate liquor to qualify based on the FDA's standard of identity for milk chocolate. This means the beneficial antioxidants found in most brands of milk chocolate are very low compared to dark chocolate. The majority of consumers don't understand that different types of milk chocolate brands have significantly more milk fat than others or that some contain chocolate liquor processed with alkali which reduces antioxidants. A recent survey done by Barry Callebaut the world's largest supplier of high cocoa dark chocolate shows that 75% of consumers believe that dark chocolate is healthy and that it is good for your heart. The link to the study is below. Major global research recently has confirmed that the antioxidants in dark chocolate have a wide group of health benefits. Many top medical authorities including Cleveland Clinic say that dark chocolate has health benefits. These health benefits come from the chocolate liquor and specifically from the cocoa solids within the chocolate liquor.

http://www.foodnavigator.com/Science-Nutrition/Chocolate-taps-consumer-health-concerns

Unfortunately many consumers do not understand the distinction between the health benefits associated with dark chocolate vs. milk chocolate and accordingly consumers consume milk chocolate in the belief that it offers considerable health benefits. The unintended result is that current formulations of milk chocolate contribute substantially to the global epidemic of obesity, heart disease, diabetes, and other health conditions because consumers eat too much saturated fat, especially animal saturated fat, such as milk fat and processed refined sugar in their diets. Milk chocolate contributes large amounts of both animal milk fat and refined sugar to the diet of global consumers. Consumers are bombarded by advertising and opportunities to purchase products that are made from chocolate and most are made from milk chocolate.

Through years of experimentation and research and development our invention produces compositions of non-standardized milk chocolate and standardized milk chocolate compositions that provide great taste and improved health characteristics in milk chocolate by improving the antioxidant content, improving the fat structure within the milk chocolate, by lowering milk fat in certain embodiments, improving the ratio of saturated, monounsaturated, and polyunsaturated fats, lowering the sugar level content with the compositions while maintaining taste, texture, melt, and creaminess necessary for consumer acceptance. We use a novel synergistic antioxidant flavor profile and in certain compositions actually change the structure of milk to include higher beneficial cocoa antioxidants and a better overall balance of fats in the compositions. We are able to create much higher chocolate liquor component milk chocolate products up to even 45% cocoa content while maintaining the rich and creamy taste that the consumers prefer in a milk chocolate product. We create these non-standardized milk chocolate compositions through a double blending process that creates a creaminess in the non-standardized milk chocolate which is similar to a much higher milk fat milk chocolate product. This allows us to create a much healthier ingredient profile milk chocolate composition that is widely accepted by consumers based on taste, texture, melt, and creaminess. We have conducted consumer taste panels, which confirm this fact that we can create non-standardized and standardized milk chocolate compositions that consumers rate high on the important sensory aspects that milk chocolate must have to gain wide consumer acceptance in the market place. See tables 1 & 2.

It is another object of the present invention to provide a non-standardized milk chocolate composition that can claim a nutritional structure that the medical community including the FDA would concede is heart healthy. Within certain embodiments of this invention we can create milk chocolate compositions with superior taste that have up to 25% to 75% less milk fat (based on an industry average of 8% milk fat) and in some compositions 0% milk fat. These milk chocolate compositions actually have increased antioxidant content, less sugar and utilize a 100% cocoa powder, confectionery sugar, and healthier edible oil combination that replace the milk fat and sugar and give the compositions the rich and creamy aspect that milk fat usually provides. Our milk chocolate compositions also can avoid using cocoa solids processed with alkali because the group of ingredients that make up our synergistic antioxidant flavor profile including; Virgin Coconut Oil, Vanilla Powder, Blackberry Powder and Acai Berry Extract reduce the bitterness and aftertaste of the cocoa solids in our compositions. Based on this completely new structure of a non-standardized milk chocolate composition we believe that a heart healthy claim is within reach for our compositions. Below is a link to a site that shows the FDA approval for allowing Frito Lay to market snacks that have substantial amounts of saturated fats replaced with unsaturated fats. Science links the replacement of saturated fats with unsaturated fats as a way to reduce the risk of heart disease.

http://www.foodnavigator-usa.com/Financial-Industry/FDA-approves-unsaturated-fat-health-claim

Milk chocolate while having some nutritional value in its content is very high in saturated fat especially milk fat and a serving of most milk chocolate products like Lindt Milk Chocolate delivers 14 grams of saturated fat per serving. The ability to reduce the milk fat content while actually improving the health characteristics of the milk chocolate compositions can have a profound effect on consumer's overall health. Millions of pounds of milk fat can be removed from the diets of global consumers with certain embodiments of our invention that reduce milk fat content and actually improve the balance of dietary fats including the addition of good monounsaturated and polyunsaturated fat content.

These and other objects are achieved using novel confectionery non-standardized milk chocolate compositions or using standardized milk chocolate compositions. The compositions contain confectionery ingredients that make the compositions great tasting and actually have in many cases improved taste characteristics as well as improved health characteristics. The compositions can be available to the consumer in convenient, chocolate squares, chocolate tablet bars, other molded confectionery shapes, or other confectionery uses including enrobing, coating, or mixed confectionery products where other ingredients are added into the compositions.

In one embodiment of the present invention a non-standardized milk chocolate composition has the following characteristics that provide additional antioxidant content, less sugar, and an improved balance of dietary fat that within certain embodiments can provide essential fatty acids including Omega 6 and Omega 3 within the milk chocolate composition with great taste, texture, melt, and creaminess.

Such a composition comprises:
a. 40% to 95% a standardized milk chocolate with 8% milk fat to milk fat free milk chocolate
b. 0% to 60% a chocolate component
c. 0.001% to 15% edible oil component (blend of canola, soybean, and olive oil)
d. 0.001% to 20% 100% cocoa powder component
e. 0.001% to 20% confectionery sugar component
f. 0% to 2% cocoa seed butter crystals component
g. 0.001% to 5% virgin coconut oil component
h. 0.001% to 5% vanilla powder component
i. 0.001% to 4% blackberry powder component
j. 0% to 1% Acai Berry Extract component

An embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive oil), by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive oil) by weight of said composition; d. 0.001% to 20% 100% cocoa powder component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition; h. and a 0.001% to 5% vanilla powder component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition; h. and a 0.001% to 5% vanilla powder component, by weight of said composition; i. and a 0.001% to 4% blackberry powder component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition; h. and a 0.001% to 5% vanilla powder component, by weight of said composition; i. a 0.001% to 4% blackberry powder component, by weight of said composition; j. and 0% to 1% Acai Berry Extract component, by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition; h. and a 0.001% to 5% vanilla powder component, by weight of said composition; i. a 0.001% to 4% blackberry powder component, by weight of said composition; j. 0% to 1% Acai Berry Extract component, by weight of said composition; and at least about 0% wt. % or greater of a supplement selected from the group consisting of: vitamins, minerals, herbs, botanicals, plant derived supplements, animal derived supplements, therapeutic compounds, and mixtures thereof; by weight of said composition.

A further embodiment of the present invention is a composition comprising: a. 40% to 95% a milk chocolate component, by weight of said composition; b. 0% to 60% a chocolate component, by weight of said composition; c. 0.001% to 15% an edible oil component (blend of canola, soybean, and olive); d. 0.001% to 20% 100% cocoa powder component, by weight of said composition; e. and 0.001% to 20% confectionery sugar component, by weight of said composition; f. and 0% to 2% cocoa seed butter crystals component, by weight of said composition; g. and 0.001% to 5% virgin coconut oil component, by weight of said composition; h. and a 0.001% to 5% vanilla powder component, by weight of said composition; i. a 0.001% to 4% blackberry powder component, by weight of said composition; j. 0% to 1% Acai Berry Extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component selected from the group consisting of a flavor component, a color component, a preservative component.

Additionally, an embodiment of the present invention is a composition comprising the steps of: a. melting the standardized milk chocolate and chocolate if necessary tempering it in a mixing vessel or then putting it into a mixing vessel that can keep the temperature at 92 degrees Fahrenheit or higher; b. add the 0% to 2% cocoa seed butter crystals; c. add the 0.001% to 5% vanilla powder component, by weight of said component; d. add the 0.001% to 4% blackberry powder component, by weight of said composition; e. add the 0% to 1% Acai Berry extract component, by weight of said composition.

In a separate mixing vessel that can heat the ingredients to 92 degrees Fahrenheit or higher add: a. 0.001% to 15% edible oil component, by weight of said composition; b. add the 0.001% to 20% confectionery sugar component, by weight of said composition; c. add the 0.001% to 5% virgin coconut oil, by weight of said composition and mix until homogeneous; d. then blend the 0.001% to 20% 100% cocoa powder, by weight of said composition into the mixture until completely homogeneous. Combine the ingredients in the second mixing vessel that includes the edible oil, 100% cocoa powder, confectionery sugar, and virgin coconut oil with the first mixing vessel that has the standardized milk chocolate, chocolate if necessary, cocoa seed butter crystals if necessary, vanilla powder, blackberry powder and Acai Berry extract if necessary and blend until completely homogeneous. Then add at least about 0% wt. % or greater of a supplement selected from the group consisting of: vitamins, minerals, herbs, botanicals, plant derived supplements, animal derived supplements, therapeutic compounds, and mixtures thereof; by weight of said composition; and add an additional component selected from the group consisting of a flavor component, a color component, a preservative component. The complete group of ingredients would be mixed until completely homogeneous; thus, creating a double blended non-standardized milk chocolate composition.

In second embodiment of the invention a standardized milk chocolate composition has the following characteristics that can lower the milk fat content and sugar level with the addition of an antioxidant flavor profile that produces a great taste, texture, melt, and creaminess milk chocolate.

Such a composition comprises:
a. 40% to 95% milk chocolate with a milk fat content of 3.69% or greater component
b. 0% to 60% a chocolate component
c. 0.001% to 5% virgin coconut oil component
d. 0.001% to 5% vanilla powder component
e. 0.001% to 4% blackberry powder component
f. 0% to 1% Acai Berry Extract component

An embodiment of the present invention is a composition comprising: a. 40% to 95% a milk chocolate with a milk fat content of 3.69% or greater component, by weight of said composition; and b. 0% to 60% a chocolate component, by weight of said composition; c. 0.001% to 5% virgin coconut oil component, by weight of said composition.

A further embodiment of the present invention is a composition comprising: a. 40% to 95% a milk chocolate with a milk fat content of 3.69% or greater component, by weight of said composition; and b. 0% to 60% a chocolate component, by weight of said composition; c. 0.001% to 5% virgin coconut oil component, by weight of said composition; and d. 0.01 to 5% a vanilla powder component, by weight of said composition.

A further embodiment of the present invention is a composition comprising: a. 40% to 95% a milk chocolate with a milk fat content of 3.69% or greater component; b. 0% to 60% a chocolate component, by weight of said composition; c. 0.001% to 5% virgin coconut oil component, by weight of said composition; d. 0.001% to 5% vanilla powder component, by weight of said composition; e. and 0.001% to 4% blackberry powder component, by weight of said composition.

A further embodiment of the present invention is a composition comprising: a. 40% to 95% a milk chocolate with a milk fat content of 3.69% or greater component; b. 0% to 60% a chocolate component, by weight of said composition; c. 0.001% to 5% virgin coconut oil component, by weight of said composition; d. 0.001% to 5% vanilla powder component, by weight of said composition; e. 0.001% to 4% blackberry powder component, by weight of said composition; and f. 0% to 1% Acai Berry extract component, by weight of said composition.

A further embodiment of the present invention is a composition comprising: a. 40% to 95% a milk chocolate with a milk fat content of 3.69% or greater component; b. 0% to 60% a chocolate component, by weight of said composition; c. 0.001% to 5% virgin coconut oil component, by weight of said composition; d. 0.001% to 5% vanilla powder component, by weight of said composition; e. 0.001% to 4% blackberry powder component, by weight of said composition; and f. 0% to 1% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition.

A further embodiment of the present invention is a composition comprising: a. 40% to 95% a milk chocolate with a milk fat content of 3.69% or greater component; b. 0% to 60% a chocolate component, by weight of said composition; c. 0.001% to 5% virgin coconut oil component, by weight of said composition; d. 0.001% to 5% vanilla powder component, by weight of said composition; e. 0.001% to 4% blackberry powder component, by weight of said composition; and f. 0% to 1% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component selected from the group consisting of a flavor component, a color component, a preservative component.

Additionally, an embodiment of the present invention is a composition comprising the steps of: a. melting the standardized milk chocolate and chocolate if and temper the chocolate material in a mixing vessel or then putting it into a mixing vessel; b. add the virgin coconut oil component in the mixing vessel; c. add the vanilla powder component to the mixing vessel; d. add blackberry powder component in the mixing vessel; e. add the Acai berry extract component to the mixing vessel and mix until a homogeneous mixture.

Additionally, an embodiment of the present invention is a composition comprising the steps of: a. melting the milk chocolate and chocolate if necessary tempering it in a mixing vessel or then putting it into a mixing vessel that can keep the temperature at 92 degrees Fahrenheit or higher; b. add the virgin coconut oil to the mixing vessel; c. add the vanilla powder component to the mixing vessel; d. add the blackberry powder in the mixing vessel; e. add the Acai berry extract component to the mixing vessel and mix until a homogeneous mixture. Add to above blended composition 0% or greater a supplement component and a preservative component if necessary.

### DETAILED DESCRIPTION

Definitions

All percentages and ratios are calculated by weight unless otherwise indicated. All percentages and ratios are calculated based on the total final composition unless otherwise indicated.

Referenced herein may be trade names for components including various ingredients utilized in the present invention. The inventors herein do not intend to be limited by materials under a given trade name. Equivalent materials (e.g., those obtained from a different source under a different name or reference number) to those referenced by trade name may be substituted and utilized in the description.

The Invention

Generally, as known in prior art many patents have been granted for creating low fat or reduced fat milk chocolate products. Most of these inventions were simply trying to reduce the total amount of fat in the milk chocolate products. Some milk chocolate patents add water to the compositions in an attempt to create a milk chocolate with less total fat. Our current invention focuses on improving a broad range of health characteristics in milk chocolate (improved antioxidant content, substantially lower milk fat, lower sugar) and expanding the potential consumer market for this healthier profile milk chocolate by providing improvements in the taste, texture, melt, and creaminess consumers seek in regular milk chocolate products. Many producers have tried just adding healthy ingredients to milk chocolate with the belief that the consumer will buy them on the basis of these healthy ingredients. Mars incorporated created a product called Dove Beautiful. This was a milk chocolate containing additives and claimed to improve skin health. The product suffered from poor taste versus Dove's regular silky smooth milk chocolate and the product eventually was pulled from the market.

The uniqueness and novelty of the current invention is that we can improve the health characteristics of milk chocolate at the same time maintaining the taste, texture, melt, and creaminess and certain embodiments improve the taste, texture, melt, and creaminess versus regular milk chocolate. The ability of our milk chocolate compositions to actually taste better than regular brand competitors is a critical accomplishment of our invention and novel technology. Table 3 below shows the results of how well our product scored on a taste comparison between our 25% less milk fat (based on an industry average of 8% milk fat) and 35% Cocoa content non-standardized milk chocolate versus Ghirardelli's Luxe Milk chocolate, Hershey's Milk Chocolate and Dove Silky Smooth Milk Chocolate. As shown in table 3 the non-standardized milk chocolate composition with 25% less milk fat versus (industry average of 8% milk fat) and 35% Cocoa content created with this invention scored same as or higher than competition on the major consumer sensory aspects of milk chocolate including: taste, texture, melt, creaminess, mouthfeel, finish, aftertaste, experience, and overall.

Another important aspect of this invention is that within certain embodiments we can create milk chocolate compositions that have nutritional contents that allow for the present invention to be physician recommended. A vast majority of medical professionals including Harvard Medical School Public Health states that milk chocolate is too low in beneficial antioxidants and too high in saturated milk fat to qualify as an everyday healthy food. In certain combinations of the ingredients within our non-standardized milk chocolate compositions we can create a milk chocolate composition with 45% cocoa content while reducing the milk fat content up to 100% while maintaining good taste, texture, melt, and creaminess structure product.

Normal Milk Chocolate in a serving size of 40 grams and would have a total fat content of 17 grams with 12 grams of saturated fat. Our 45% Cocoa milk chocolate compositions with 25% less milk fat have a nutritional structure of a 40 gram serving size of 16 grams of total fat with 7 grams of saturated fat. Embodiments of the present invention can create non-standardized milk chocolate compositions that have up to 100% less milk fat versus regular milk chocolate and with significantly more beneficial antioxidants and less sugar. This formulation offers a far superior nutritional profile non-standardized milk chocolate composition vs. physician recommendations for the everyday healthy daily diet compared to normal milk chocolate formulations.

Through experimentation and extensive research and development it was discovered that an embodiment of the present invention comprises a composition having: a. 40% to 95% a milk chocolate component, by weight of said composition; b. 0% to 60% a chocolate component, by weight of said composition; c. 0.001% to 15% an edible oil component, by weight of said composition; d. 0.001% to 20% a 100% cocoa component, by weight of said component; e. 0.001% to 20% a confectionery sugar component, by weight of said composition; f. 0% to 2% cocoa seed butter crystals, by weight of said composition; g. 0.001% to 5% virgin coconut oil component, by weight of said composition; h. 0.001% to 5% vanilla powder component, by weight of said component; i. 0.001% to 4% blackberry powder component, by weight of said composition; and j. 0% to 1% Acai Berry exctract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component selected from the group consisting of a flavor component, a color component, a preservative component.

Milk Chocolate Component

The composition of the present invention comprises at least about 40% of a milk chocolate component, alternately, 40% to 45%, alternately 45% to 50%, alternatively 50% to 55%, alternatively 55% to 60%, alternatively 60% to 65%, alternatively 65% to 70%, alternatively 70% to 75%, alternatively 75% to 80%, alternatively 80% to 85%, alternatively 85% to 90%, alternatively 90% to 95%, of a milk chocolate component, by weight, of said composition.

The preferred embodiment of the invention would use a milk chocolate component that has no artificial flavors and that is not processed with alkali. Finally, in the preferred embodiment of the invention the milk chocolate would have a 3.69% to 8% milk fat content. An example of a milk chocolate product with these attributes is Natural Milk 823 sold by Barry Callebaut a global chocolate raw material supplier. A low milk fat milk chocolate with a fat content from 3.69% down to skim milk chocolate that is milk fat free could be used within certain embodiments of the invention. While milk chocolate that is processed with alkali, that has artificial flavors added to it, and that has a milk fat content above 8% could be used within the invention it would be counterproductive to the concept of producing a milk chocolate composition with improved health characteristics, higher antioxidant content, lower sugar levels, and lower milk fat.

Chocolate Component

The composition of the present invention comprises at least about 0% to 60% of a chocolate component, alternately at least about 55% to 60%, alternatively 50% to 55%, alternately 45% to 50%, alternately 40% to 45%, alternately 35% to 40%, alternately 30% to 35%, alternately 25% to 30%, alternately 20% to 25%, alternately 15% to 20%, alternately 10% to 15%, alternately 5% to 10%, alternately 0% to 5% of a chocolate component, by weight, of said composition.

The preferred embodiment of the invention would use a chocolate component with 35% cocoa to 99% cocoa that has no milk or milk fat added to the chocolate used. The chocolate component also needs to not be processed with alkali. Finally, in the preferred embodiment of the invention the chocolate component would be all natural and would have no artificial flavors. An example of a chocolate product with these attributes is Tulsa Dark sold by Barry Callebaut a global chocolate raw material supplier. While chocolate that has milk or milk fat added to it, is processed with alkali, and that has artificial flavors added to it could be used within the invention it would be counterproductive to the concept of producing a milk chocolate with improved health characteristics and the listed additives above lower the health characteristics of the chocolate.

Edible Oil Component

The composition of the present invention includes an edible oil component at 0.001% to 15%, alternatively 0.001% to 5%, alternatively 5% to 10%, alternatively 10% to 15%, by weight of said composition. This edible oil component makes up part of the group of ingredients that improve the milk chocolate taste, texture, melt and creaminess. The edible oil component also improves the health characteristic of the milk chocolate because it adds monounsaturated and polyunsaturated fats to milk chocolate that are devoid. The edible oil component also displaces milk fat and sugar in the non-standardized milk chocolate compositions as it can be a large percentage of the overall compositions. An example of an edible oil component is a blend of canola, soybean oil, and olive oil. Another example would be a blend of canola, soybean oil, and sunflower oil. Non-limiting examples of an edible oil component acceptable for the present invention need to have low saturated fat content and high unsaturated fat including monounsaturated and especially polyunsaturated oils. The edible oil component needs to have no specific flavor and needs to be basically bland or somewhat buttery in taste. The edible oils component can come from the following; canola oil, soybean oil, safflower oil, sunflower oil, sesame oil, walnut oil, olive oil, flaxseed oil, chia seed oil, almond oil, corn oil, grape seed oil, peanut oil, other nut oils, other seed oils, or other edible oils with a high level of unsaturated fat and combinations thereof.

100% Cocoa Powder Component

The composition of the present invention includes a 100% Cocoa component at 0.001% to 20%, alternatively 0.001% to 5%, alternatively 5% to 10%, alternatively 10% to 15%, alternatively 15% to 20%, by weight of said composition. The 100% cocoa component makes up part of the group of ingredients that adjust the milk chocolate taste, texture, melt, and creaminess. The 100% Cocoa component also improves the health characteristic of the invention because 100% Cocoa actually has the highest antioxidant content of all the cocoa bean parts. An example of a 100% cocoa component acceptable for the present invention is a Natural 100% Cocoa Powder supplied by Barry Callebaut. While this Natural 100% Cocoa is acceptable any 100% Cocoa Powder supplied from a vendor is suitable and preferred to be non-dutched or not processed with alkali. A cocoa component less than 100% cocoa powder can be used, but usually sugar is just added to cocoa powders to lower the cocoa content and our composition uses confectionery sugar as a component instead of having the sugar in the cocoa powder.

Confectionery Sugar Component

The composition of the present invention includes a confectionery sugar component at 0.001% to 20%, alternatively 0.001% to 5%, alternatively 5% to 10%, alternatively 10% to 15%, alternatively 15% to 20%, by weight of said composition. The confectionery sugar component makes up part of the group of ingredients that adjust the milk chocolate taste, texture, melt, and creaminess. Any suitable confectionery sugar component can be used within the invention. The only important aspect is that the confectionery sugar be natural and that it has a fine standard milled characteristic.

Cocoa Seed Butter Crystals

The composition of the present invention can comprise from 0% to 2% Cocoa Seed Butter Crystals that improve the set of the non-standardized milk chocolate compositions. As Cocoa Butter becomes lower in chocolate the tempering and the ultimate set of the product is affected. In certain embodiments of this invention edible oils are added to the composition that improve the balance of fats in the compositions and can add essential fatty acids including Omega 6 and Omega 3. This addition of the healthier edible oils loaded towards the higher range of the 0.001% to 15%, by weight of the non-standardized milk chocolate compositions may require the addition of cocoa seed butter crystals to improve tempering and the ultimate set and hardness of the finish non-standardized milk chocolate compositions.

Virgin Coconut Oil Component

The composition of the present invention comprises 0.001% to 5% of a virgin coconut oil component, by weight of said composition. This virgin coconut oil component makes up part of the antioxidant blend flavor profile that has a synergistic effect on the milk chocolate compositions. The blend of the flavor components is a critical aspect of how the present invention accomplishes the great taste while having improved health characteristics including higher antioxidant content, less sugar content, and lower milk fat content. Therefore, it is necessary for the virgin coconut oil component to have a good flavor profile and not to have any of the flavor profile removed by processing the oil. Nature's Flavors supplies a Kosher virgin coconut oil that has good flavor and works well within the present invention.

Vanilla Powder Component

The composition of the present invention includes a vanilla powder component at 0.001% to 5%, by weight of said invention. This vanilla powder component makes up part of the antioxidant blend flavor profile that has a synergistic effect on the milk chocolate compositions. The blend of flavor components is a critical aspect of how the present invention accomplishes the great taste and improved health characteristics of the compositions. Therefore, it is necessary for the vanilla powder component to have a specific flavor profile and Cook's Flavoring Company currently sells the vanilla powder that is within the flavor component of the present invention. Another vanilla powder or natural vanilla flavor could be used, but it would have to have a similar taste profile and must have a similar effect on the taste profile of the milk chocolate compositions. While the vanilla powder used is a natural form of vanilla an artificial vanilla flavor could be substituted with less successful results.

Blackberry Powder Component

The composition of the present invention includes a blackberry powder component at 0.001% to 4%, by weight of said composition. This blackberry powder component makes up part of the flavor profile that has a synergistic effect on the milk chocolate compositions. The blend of flavor components that include blackberry powder is a critical aspect of how the present invention accomplishes the great taste and improved health characteristics of the compositions. Therefore, it is necessary for the blackberry powder component to have a specific flavor profile and Decas Botanicals supplies the current blackberry powder component. Other blackberry powder's can be substituted for the Decas Botanicals product, but the blackberry powder would need to have similar characteristics. The blackberry powder can be included as currently 60 mesh milled or the blackberry powder can be milled to 100% through 120 mesh that makes the blackberry fine milled and adds no grit or texture change within the composition.

While blackberry powder is the preferred flavor ingredient in the present invention other berry powders could be used including; raspberry, Marion blackberry, black raspberry, or other berry powders that can produce a similar taste profile as the blackberry powder can produce within the present invention. These additional types of berry powders can be milled to 100% through 120 mesh that makes fine milled berry powder and adds no grit or texture change within the composition.

Acai Berry Extract Component

The composition of the present invention can include an Acai Berry Extract component at 0% to 1%, by weight of said composition. The Acai Berry Extract component can be added to the milk chocolate compositions for additional flavor and health benefits. It isn't a critical aspect of the flavor profile, but does add some unique characteristics based on its nutritional profile. Jarchem a supplier out of New Jersey sells several forms of Acai Berry Extract that can be used if desired for additional flavor and health benefits in the milk chocolate compositions.

The edible oil component, 100% cocoa powder component, confectionery sugar component, virgin coconut oil, vanilla powder component, blackberry powder and Acai berry extract component, together create a unique novel synergistic effect that creates a undetermined physical change within the milk chocolate compositions and allows for a final milk chocolate composition that can have 25% to 75% less milk fat (compared to industry average of 8% milk fat) and within certain embodiments of this invention 100% less milk fat than regular standardized milk chocolate products. This lower milk fat percentage is based on an industry average of 8% milk fat in regular milk chocolate products. These lower milk fat milk chocolate compositions created within this invention can create excellent taste, texture, melt, and creaminess while significantly improving the health characteristics, improving the antioxidant content, and reducing the sugar content compared to regular milk chocolate products.

Supplement Component

Additionally, embodiments of the present invention can produce compositions that can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively 20% to 25%, alternatively 15% to 20%, alternatively from about 10% to about 15%, and alternatively from about 5% to about 10%, alternatively 0% to 5% by weight of the composition, of a supplement component.

Flavor, Colorant and Preservative Components

Various additional components including natural and artificial flavors, natural and artificial sweeteners, and natural and artificial colorants and/or food grade dyes can be included in the compositions of the present invention. In addition, various preservatives, as would be understood by those of ordinary skill in the art can also be added.

Non-limiting examples of flavors include natural or artificial flavors and include chocolate; vanilla; caramel; coffee; fruit flavors including lemon, lime, orange, blackberry, raspberry, blueberry, peach, apricot, cherry, grape; and mixtures thereof.

Such flavors can be purchased, and/or prepared and added using known flavor technologies.

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0%, by weight of the composition, of flavor, colorant and/or preservative components, and mixtures thereof. Alternatively, the compositions of the present invention can include from about 0% to about 5%, alternatively from about 5% to about 10%, and alternatively from about 10% to about 15%, by weight of the composition, of flavor, colorant components and/or mixtures thereof.

Method of Making

Example methods of preparing compositions of the present invention can comprise steps selected from the steps of: a. melting the standardized milk chocolate and chocolate if necessary and tempering it in a mixing vessel or then putting it into a mixing vessel; b. add the virgin coconut oil to the mixing vessel if making a standardized milk chocolate composition or the virgin coconut oil would be part of the second mixing vessel if making a non-standardized milk chocolate composition; c. add the vanilla powder component to the mixing vessel; d. add the blackberry powder in the mixing vessel; e. add the Acai berry extract component if necessary to the mixing vessel and mix until a homogeneous mixture for a standardized milk chocolate composition.

In a separate mixing vessel; a. add the virgin coconut oil component to the mixing vessel; b. add the edible oil component to the mixing vessel; c. add the confectionery sugar to the mixing vessel; d. add the 100% cocoa component to the mixing vessel and mix until said group of ingredients are completely blended into a homogeneous mixture. Add the contents of the second mixing vessel into the first mixing vessel and mix both contents until homogeneous; thus creating said double blended non-standardized milk chocolate composition.

Additionally, an embodiment of the present invention is a composition comprising the steps of: a. melting the standardized milk chocolate and chocolate if necessary and tempering it in a mixing vessel or then putting it into a mixing vessel that can keep the temperature at 92 degrees Fahrenheit or higher; b. add the virgin coconut oil to the mixing vessel now if making a standardized milk chocolate composition or in the second mixing vessel for a non-standardized milk chocolate composition; c. add the vanilla powder component to the mixing vessel; d. add blackberry in the mixing vessel; e. add the Acai berry extract component if necessary to the mixing vessel and mix until a homogeneous mixture for a standardized milk chocolate composition or the homogeneous mixture would be added to the materials in the second mixing vessel for a non-standardized milk chocolate composition.

In a separate mixing vessel at 92 degrees Fahrenheit or above; a. add the virgin coconut oil component to the mixing vessel; b. add the edible oil component to the mixing vessel; c. blend the confectionery sugar component into the mixture until completely homogeneous; d. then add the 100% cocoa component to the mixing vessel and mix until said group of ingredients are completely blended into a homogeneous mixture. Add the contents of the second mixing vessel into the first mixing vessel and mix both contents keeping the temperature at least at 92 degrees Fahrenheit in order to keep the composition properly tempered until homogeneous; thus creating said double blended non-standardized milk chocolate composition. The double blending of the present embodiment of this invention also increases the rich and creamy taste, texture, and melt of our non-standardized milk chocolate compositions created within this invention.

The final mixture can be made using a traditional chocolate molding line. The final compositions will be either made into molded squares or bars or other molded shapes by the traditional chocolate molding line. The squares or bars or shapes produced would be flow wrapped into foil wrappers or foiled with wrapper such as is standard for confectionery chocolate squares or bars in the industry. These packaged individual squares or bars can then be placed in secondary packaging; non-limiting examples include cartons, bags, pop boxes, or sleeves; and combinations thereof.

### Examples

The below examples are included for illustrative purposes only and are not intended to in any way limit the scope of the present invention.

### Example 1

Non-standardized milk chocolate with 25% Less Milk Fat Than Regular Milk Chocolate with Improved Health Characteristics, Higher Antioxidant Content, Lower Sugar Content, and Improved Taste, Texture, Melt, and Creaminess

At room temperature add 16 ounces of Natural Milk 823 brand milk chocolate supplied by Barry Callebaut to a melting confectionery mixer that can also temper the chocolate. Melt and temper the 16 ounces of Natural Milk chocolate and make sure it stays at 92 degrees Fahrenheit or above. Then add 12 grams of vanilla powder to the melted chocolate. Then add 4 grams of blackberry powder to the melted chocolate. Then add 1.3 grams of Acai Berry extract to the melted chocolate. Blend these ingredients together until completely homogeneous. In a separate mixing container add 8 grams of virgin coconut oil. Add 1.2 ounces of Crisco Vegetable Oil Blend (canola oil, soybean oil, sunflower oil). Then add 1 oz. of confectionery sugar into the oil blend and heat while mixing until completely homogeneous then add the 1 oz. of Natural Cocoa Powder 100% Cocoa Powder sold by Barry Callebaut. Continue to heat the ingredients to 92 degrees Fahrenheit until the blend is completely homogeneous. Then add the contents of the second container that includes the coconut oil, edible vegetable oil, 100% cocoa powder, and confectionery sugar to the first mixing vessel. Blend until the two mixtures become completely homogenous; thus created a double blended non-standardized milk chocolate composition. Then add a preservative component of tocopherols supplied by Gillco at 0.001% of the total composition or 0.071 grams that promotes freshness. Blend the tocopherol into the mixture for a minimum of 10 minutes. The blended Non-standardized Milk Chocolate Composition would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This non-standardized milk chocolate composition and specific formula and method of processing can be scaled up into major production utilizing a complete confectionery manufacturing line. In this case all the ingredients and steps in the process would be large scale commercialized.

### Example 2

Non-standardized Milk chocolate with 50% Less Milk Fat Than Regular Milk Chocolate with Improved Health Characteristics, Higher Antioxidant Content, Lower Sugar Content, and Great Taste, Texture, Melt, and Creaminess

At room temperature add 16 ounces of Natural Milk 823 brand milk chocolate and 4 ounces of Tulsa Dark both supplied by Barry Callebaut to a melting confectionery mixer that can also temper the chocolate. Melt and temper the 16 ounces of Natural Milk chocolate and 4 ounces of Tulsa Dark and make sure it stays at 92 degrees Fahrenheit or above. Then add 12 grams of vanilla powder to the melted chocolate. Then add 4 grams of blackberry powder to the melted chocolate. Then add 1.3 grams of Acai Berry extract to the melted chocolate. Blend these ingredients together until completely homogeneous. In a separate mixing container add 8 grams of virgin coconut oil. Add 1.4 ounces of Crisco Vegetable Oil Blend (canola oil, soybean oil, sunflower oil). Then add 1.2 oz. of confectionery sugar into the oil blend and heat while mixing until completely homogeneous then add the 1.2 oz. of Natural Cocoa Powder 100% Cocoa Powder sold by Barry Callebaut. Continue to heat the ingredients to 92 degrees Fahrenheit until the blend is completely homogeneous. Then add the contents of the second container that includes the coconut oil, edible vegetable oil, 100% cocoa powder, and confectionery sugar to the first mixing vessel. Blend until the two mixtures become completely homogenous; thus creating a double blended non-standardized milk chocolate composition with 50% less milk fat than regular milk chocolate. Then add a preservative component of tocopherols supplied by Gillco at 0.001% of the total composition that promotes freshness. Blend the tocopherol into the mixture for a minimum of 10 minutes. The blended Non-standardized Milk Chocolate Composition would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This non-standardized milk chocolate composition and specific formula and method of processing can be scaled up into major production utilizing a complete confectionery manufacturing line. In this case all the ingredients and steps in the process would be large scale commercialized.

Through experimentation and extensive research and development it was discovered that an embodiment of the present invention comprises a composition comprising: a. 40% to 95% a milk chocolate with a milk fat content of 3.69% or greater component; b. 0% to 60% a chocolate component, by weight of said composition; c. 0.001% to 5% virgin coconut oil component, by weight of said composition; d. 0.001% to 5% vanilla powder component, by weight of said composition; e. 0.001% to 4% blackberry powder component, by weight of said composition; and f. 0% to 1% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component selected from the group consisting of a flavor component, a color component, a preservative component.

Milk Chocolate Component

The composition of the present invention comprises at least about 40% to 95% a milk chocolate component, alternately 40% to 45%, alternatively 45% to 50%, alternatively 50% to 55%, alternatively 55% to 60%, alternatively 60% to 65%, alternatively 65% to 70%, alternatively 70% to 75%, alternatively 75% to 80%, alternately 85% to 90%, alternately 90% to 95%, of a milk chocolate component, by weight, of said composition.

The preferred embodiment of the invention would use a milk chocolate component that has no artificial flavors and that is not processed with alkali. Finally, in the preferred embodiment of the invention the milk chocolate would have a 3.69% to 8% milk fat content. An example of a milk chocolate product with these attributes is Natural Milk 823 sold by Barry Callebaut a global chocolate raw material supplier. While milk chocolate that is processed with alkali, that has artificial flavors added to it, and that has a milk fat content above 8% could be used within the invention it would be counterproductive to the concept of producing a milk chocolate composition with improved health characteristics, higher antioxidant content, lower sugar levels, and lower milk fat.

Chocolate Component

The composition of the present invention comprises at least about 0% to 60% of a chocolate component, alternately at least about 55% to 60%, alternatively 50% to 55%, alternately 45% to 50%, alternately 40% to 45%, alternately 35% to 40%, alternately 30% to 35%, alternately 25% to 30%, alternately 20% to 25%, alternately 15% to 20%, alternately 10% to 15%, alternately 5% to 10%, alternately 0% to 5% of a chocolate component, by weight, of said composition.

The preferred embodiment of the invention would use a chocolate component with 35% cocoa to 99% cocoa that has no milk or milk fat added to the chocolate used. The chocolate component also needs to not be processed with alkali. Finally, in the preferred embodiment of the invention the chocolate component would be all natural and would have no artificial flavors. An example of a chocolate product with these attributes is Tulsa Dark sold by Barry Callebaut a global chocolate raw material supplier. While chocolate that has milk or milk fat added to it, is processed with alkali, and that has artificial flavors added to it could be used within the invention it would be counterproductive to the concept of producing a milk chocolate with improved health characteristics and the listed additives above lower the health characteristics of the chocolate.

Virgin Coconut Oil Component

The composition of the present invention comprises 0.001% to 5% of a virgin coconut oil component, by weight of said composition. This virgin coconut oil component makes up part of the antioxidant blend flavor profile that has a synergistic effect on the milk chocolate compositions. The blend of the flavor components is a critical aspect of how the present invention accomplishes the great taste while having improved health characteristics including higher antioxidant content, less sugar content, and lower milk fat content. Therefore, it is necessary for the virgin coconut oil component to have a good flavor profile and not to have any of the flavor profile removed by processing the oil. Nature's Flavors supplies a kosher virgin coconut oil that has good flavor and works well within the present invention.

Vanilla Powder Component

The composition of the present invention includes a vanilla powder component at 0.001% to 5%, by weight of said invention. This vanilla powder component makes up part of the antioxidant blend flavor profile that has a synergistic effect on the milk chocolate compositions. The blend of flavor components is a critical aspect of how the present invention accomplishes the great taste and improved health characteristics of the compositions. Therefore, it is necessary for the vanilla powder component to have a specific flavor profile and Cook's Flavoring Company currently sells the vanilla powder that is within the flavor component of the present invention. Another vanilla powder or natural vanilla flavor could be used, but it would have to have a similar taste profile and must have a similar effect on the taste profile of the milk chocolate compositions. While the vanilla powder used is a natural form of vanilla an artificial vanilla flavor could be substituted with less successful results.

Blackberry Powder Component

The composition of the present invention includes a blackberry powder component at 0.001% to 4%, by weight of said composition. This blackberry powder component makes up part of the flavor profile that has a synergistic effect on the milk chocolate compositions. The blend of flavor components that includes blackberry powder is a critical aspect of how the present invention accomplishes the great taste and improved health characteristics of the compositions. Therefore, it is necessary for the blackberry powder component to have a specific flavor profile and Decas Botanicals supplies the current blackberry powder component. Other blackberry powder's can be substituted for the Decas Botanicals product, but the blackberry powder would need to have similar characteristics. The blackberry powder can be included as currently 60 mesh milled or the blackberry powder can be milled to 100% through 120 mesh that makes the blackberry fine milled and adds no grit or texture change within the composition.

While blackberry powder is the preferred flavor ingredient in the present invention other berry powders could be used including; raspberry, Marion blackberry, black raspberry, or other berry powders that can produce a similar taste profile as the blackberry powder can produce within the present invention. These additional types of berry powders can be milled to 100% through 120 mesh that makes fine milled berry powder and adds no grit or texture change within the composition.

Acai Berry Extract Component

The composition of the present invention can include an Acai Berry Extract component at 0% to 1%, by weight of said composition. The Acai Berry Extract component can be added to the milk chocolate compositions for additional flavor and health benefits. It isn't a critical aspect of the flavor profile, but does add some unique characteristics based on its nutritional profile. Jarchem a supplier out of New Jersey sells several forms of Acai Berry Extract that can be used if desired for additional flavor and health benefits in the milk chocolate compositions.

The edible oil component, 100% cocoa powder component, confectionery sugar component, virgin coconut oil, vanilla powder component, blackberry powder component, and Acai berry extract component, together create a unique novel synergistic effect that creates a undetermined physical change within the milk chocolate compositions and allows for a final milk chocolate composition that can have less milk fat, less sugar and improved health characteristics including higher antioxidant content. These lower milk fat milk chocolate compositions created within this invention can create excellent taste, texture, melt, and creaminess while significantly improving the health characteristics, improving the antioxidant content, and reducing the sugar content compared to regular milk chocolate products.

Supplement Component

Additionally, embodiments of the compositions of the present invention can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively from about 0% to about 10%, and alternatively from about 0% to about 5%, by weight of the composition, of a supplement component.

Flavor, Colorant and Preservative Components

Various additional components including natural and artificial flavors, natural and artificial sweeteners, and natural and artificial colorants and/or food grade dyes can be included in the compositions of the present invention. In addition, various preservatives, as would be understood by those of ordinary skill in the art can also be added.

Non-limiting examples of flavors include natural or artificial flavors and include chocolate; vanilla; caramel; coffee; fruit flavors including lemon, lime, orange, blackberry, raspberry, blueberry, peach, apricot, cherry, grape; and mixtures thereof.

Such flavors can be purchased, and/or prepared and added using known flavor technologies.

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0.001%, by weight of the composition, of flavor, colorant and/or preservative components, and mixtures thereof. Alternatively, the compositions of the present invention can include from about 0.001% to about 10%, alternatively from about 0.001% to about 5%, and alternatively from about 0.001% to about 2%, by weight of the composition, of flavor, colorant components and/or mixtures thereof.

The combination of the antioxidant flavor profile blend of virgin coconut oil, vanilla powder, blackberry powder and potentially Acai Berry Extract have a synergistic effect on the taste, texture, and creaminess melt in the standardized milk chocolate. Embodiments within this invention that utilize this synergistic antioxidant blend create milk chocolate that has the taste, texture, and melt characteristics of regular milk chocolate. These improved taste characteristics of certain embodiments within this invention have the ability to switch consumers to eating a healthier milk chocolate product compared to eating regular milk chocolate because of these improved taste characteristics. The antioxidant blend of virgin coconut oil, vanilla powder, blackberry powder, and potentially Acai Berry extract add additional healthy characteristics to standardize milk chocolate when added into the formulas as well.

Form of Composition

The compositions of the present invention can be formed into any suitable confectionery form. Non-limiting examples of the form of the compositions include: bite size pieces, squares or rectangles of specific weight, varying molded shapes or sizes including bars and tablet bars that are available for chocolate confectionery products. The compositions can be used for enrobing purposes or for combination food products that utilize high cocoa dark chocolate as an ingredient.

Method of Making

Example methods of preparing compositions of the present invention can comprise steps selected from the steps of: a. melting the standardized milk chocolate and chocolate if necessary and tempering it in a mixing vessel or then putting it into a mixing vessel; b. add the virgin coconut oil to the mixing vessel; c. add the vanilla powder component to the mixing vessel; d. add the blackberry powder component to the mixing vessel; e. add the Acai berry extract component if necessary to the mixing vessel and mix until a homogeneous mixture.

Additionally, an embodiment of the present invention is a composition comprising the steps of: a. melting the standardized milk chocolate and chocolate if necessary and tempering it in a mixing vessel or then putting it into a mixing vessel that can keep the temperature at 92 degrees Fahrenheit or higher; b. add the virgin coconut oil to the mixing vessel; c. add the vanilla powder component to the mixing vessel; d. add blackberry powder component to the mixing vessel; e. add the Acai berry extract component if necessary to the mixing vessel and mix until a homogeneous mixture.

A supplement or a preservative could be also added to the above standardized milk chocolate compositions if necessary and blended until homogeneous.

The final mixture can be made using a traditional chocolate molding line. The final compositions will be either made into molded squares or bars or other molded shapes by the traditional chocolate molding line. The squares or bars or shapes produced would be flow wrapped into foil wrappers or foiled with wrapper such as is standard for confectionery chocolate squares or bars in the industry. These packaged individual squares or bars can then be placed in secondary packaging; non-limiting examples include cartons, bags, pop boxes, or sleeves; and combinations thereof.

### Examples

The below examples are included for illustrative purposes only and are not intended to in any way limit the scope of the present invention.

### Example 1

Milk Chocolate with Higher Antioxidant Content, Less Sugar, Improved Taste, Texture, Melt, and Creaminess

At room temperature add 16 ounces of Natural Milk 823 brand milk chocolate supplied by Barry Callebaut to a melting confectionery mixer that can also temper the chocolate. Melt and temper the milk chocolate and keep it at 92 degrees Fahrenheit to maintain tempered state. Then add 12 grams of vanilla powder. Then add 12 grams of virgin coconut oil. Then add 4 grams of blackberry powder. Then add 1.3 grams of Acai Berry Extract to the mixing vessel. Mix the ingredients until completely homogeneous. The blended milk chocolate would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This standardized milk chocolate composition and specific formula and method of processing can be scaled up into major production utilizing a complete confectionery manufacturing line. In this case all the ingredients and steps in the process would be large scale commercialized.

### Example 2

45% Cocoa Milk Chocolate with Higher Antioxidant Content, Less Sugar, Great Taste, Texture, Melt, and Creaminess

At room temperature add 16 ounces of Natural Milk 823 milk chocolate supplied by Barry Callebaut and 4 ounces of Tulsa Dark a dark chocolate brand to a melting confectionery mixer that can also temper the chocolate. Melt and temper the milk chocolate and dark chocolate and keep it at 92 degrees Fahrenheit to maintain tempered state. Then add 12 grams of vanilla powder. Then add 12 grams of virgin coconut oil. Then add 4 grams of blackberry powder. Then add 1.3 grams of Acai Berry Extract to the mixing vessel. Mix the ingredients until completely homogeneous. The blended 45% Cocoa Milk Chocolate would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This standardized milk chocolate composition and specific formula and method of processing can be scaled up into major production utilizing a complete confectionery manufacturing line. In this case all the ingredients and steps in the process would be large scale commercialized.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

TABLE 1
Table 1
NON-STANDARDIZED MILK CHOCOLATE COMPOSITIONS STUDY
SENSORY RESULTS (10 CONSUMERS TASTED EACH)*

| | 25% Less | 25% Less | 35% Less | 50% Less | 50% Less | 50% Less |
|---|---|---|---|---|---|---|
| | Milk Fat** | Milk Fat | Milk Fat | Milk Fat | Milk Fat | Milk Fat |
| | 35% Cocoa | 40% Cocoa | 45% Cocoa | 35% Cocoa | 40% Cocoa | 45% Cocoa |
| Taste*** | 9**** | 9 | 9 | 8 | 8 | 8 |
| Texture | 9 | 9 | 8 | 8 | 8 | 8 |
| Melt | 9 | 9 | 9 | 9 | 9 | 9 |
| Creaminess | 9 | 9 | 9 | 9 | 9 | 9 |
| Mouthfeel | 9 | 9 | 8 | 8 | 8 | 8 |
| Finish | 9 | 8 | 8 | 8 | 8 | 8 |
| Aftertaste | 9 | 8 | 9 | 8 | 8 | 8 |
| Experience | 9 | 9 | 9 | 8 | 8 | 8 |
| Overall | 9 | 9 | 9 | 8 | 8 | 8 |

*Consumers chosen were regular milk chocolate eaters.
**Pecentage less milk fat is based on 8% industry average milk fat in milk chocolate products.
***Each sensory characteristic was rated on a scale of 1 to 9, 1 being poor and 9 being excellent.
****Each score was tabulated by taking the total number of consumers polled being 10 for each sample and adding up the total score for each sensory characteristic and then dividing by 10. This gives the average rating per 10 consumers on each sensory characteristic polled for each of the above six samples of non-standardized milk chocolate compositions created from our invention.

TABLE 2
STANDARDIZED MILK CHOCOLATE
COMPOSITIONS STUDY SENSORY RESULTS
(10 CONSUMERS TASTED EACH)*

| | Milk | Milk | Milk |
|---|---|---|---|
| | Chocolate | Chocolate | Chocolate |
| | Composition | Composition | Composition |
| | 35% Cocoa | 40% Cocoa | 45% Cocoa |
| Taste** | 9*** | 9 | 9 |
| Texture | 9 | 9 | 8 |
| Melt | 9 | 9 | 9 |
| Creaminess | 9 | 9 | 9 |
| Mouthfeel | 9 | 9 | 8 |
| Finish | 9 | 8 | 8 |
| Aftertaste | 9 | 8 | 9 |
| Experience | 9 | 9 | 9 |
| Overall | 9 | 9 | 9 |

*Consumers chosen were regular milk chocolate eaters.
**Each sensory characteristic was rated on a scale of 1 to 9, 1 being poor and 9 being excellent.
***Each score was tabulated by taking the total number of consumers polled being 10 for each sample and adding up the total score for each sensory characteristic and then dividing by 10. This gives the average rating per 10 consumers on each sensory characteristic polled for each of the above six samples of non-standardized milk chocolate compositions created from our invention.

TABLE 3
NON-STANDARDIZED MILK CHOCOLATE
COMPOSITION VS. COMPETITOR'S SENSORY RESULTS
(10 CONSUMERS TASTED EACH)*

| | Non-Standardized | | | |
|---|---|---|---|---|
| | Milk Chocolate | Ghirardelli | Hershey's | Dove |
| | 25% Less Milk Fat, | Luxe Milk | Milk | Milk |
| | 35% Cocoa Content** | Chocolate | Chocolate | Chocolate |
| Taste*** | 9**** | 8 | 8 | 9 |
| Texture | 8 | 8 | 8 | 9 |
| Melt | 9 | 8 | 7 | 8 |
| Creaminess | 9 | 9 | 8 | 9 |
| Mouthfeel | 9 | 8 | 8 | 9 |
| Finish | 8 | 8 | 7 | 8 |
| Aftertaste | 9 | 8 | 8 | 8 |
| Experience | 8 | 8 | 7 | 8 |
| Overall | 9 | 8 | 8 | 9 |

*Consumers chosen were regular milk chocolate eaters.
**25% Less milk fat versus industry average of 8% milk fat
***Each sensory characteristic was rated on a scale of 1 to 9, 1 being poor and 9 being excellent.
****Each score was tabulated by taking the total number of consumers polled being 10 for each sample and adding up the total score for each sensory characteristic and then dividing by 10. This gives the average rating per 10 consumers on each sensory characteristic polled for each of the above six samples of non-standardized milk chocolate compositions created from our invention.

1. An improved health characteristic, higher antioxidant, lower sugar, unique synergistic antioxidant blend with improved taste, texture, melt, and creaminess non-standardized milk chocolate composition with a milk fat content of 0% to 8% comprising: a. a 0% to 8% milk fat milk chocolate component at 40% or greater, by weight of said composition; b. a chocolate component at 0% to 60%, by weight of said composition; c. an edible oil blend component at 0.001% to 15%, by weight of said composition; d. a 100% Cocoa Powder component at 0.001% to 20%, by weight of said composition; e. a confectionery sugar component at 0.001% to 20%, by weight of said composition; f. a Cocoa Seed Butter Crystals component at 0% to 2%, by weight of said composition; g. a Virgin Coconut Oil component at 0.001% to 5%, by weight of said composition; h. a Vanilla Powder component at 0.001% to 5%, by weight of said composition; i. a Blackberry Powder component at 0.001% to 4%, by weight of said composition; j. an Acai Berry Extract component at 0% to 1%, by weight of said composition; and k. a supplement component at 0% to greater, by weight of said composition.

2. An improved health characteristic, higher antioxidant, lower sugar, unique synergistic antioxidant blend with improved taste, texture, melt, and creaminess standardized milk chocolate composition with a milk fat content of 3.69% to 8% comprising: a. a 3.69% to 8% standardized milk chocolate component at 40% or greater, by weight of said composition; b. a chocolate component at 0% to 60%, by weight of said composition; c. a Virgin Coconut Oil component at 0.001% to 5%, by weight of said composition; d. a Vanilla Powder component at 0.001% to 5%, by weight of said composition; e. a Blackberry Powder component at 0.001% to 4%, by weight of said composition; f. an Acai Berry Extract component at 0% to 1%, by weight of said composition; and g. a supplement component at 0% to greater, by weight of said composition.

3. The composition of claims 1 and 2 wherein the milk chocolate component is natural with no artificial flavors or isn't natural and has artificial flavors.

4. The composition of claim 3 wherein the milk chocolate component is all natural and has no artificial flavors.

5. The composition of claims 1 and 2 wherein the milk chocolate component is processed with alkali or isn't processed with alkali.

6. The composition of claim 5 wherein the milk chocolate component isn't processed with alkali.

7. The composition of claim 1 wherein said milk chocolate has 0% to 8% milk fat and is 40% to 45%, alternatively 45% to 50%, alternatively 50% to 55%, alternatively 55% to 60%, alternatively 60% to 65%, alternatively 65% to 70%, alternatively 70% to 75%, alternatively 75% to 80%, alternatively 80% to 85%, alternatively 85% to 90%, alternatively 90% to 95%, alternatively 95% to 99%, by weight of said composition.

8. The composition of claim 2 wherein said milk chocolate has 3.69% to 8% milk fat and is 40% to 45%, alternatively 45% to 50%, alternatively 50% to 55%, alternatively 55% to 60%, alternatively 60% to 65%, alternatively 65% to 70%, alternatively 70% to 75%, alternatively 75% to 80%, alternatively 80% to 85%, alternatively 85% to 90%, alternatively 90% to 95%, alternatively 95% to 99%, by weight of said composition.

9. The composition of claim 1 and claim 2 wherein the chocolate component has a cocoa component from 35% to 99%. The composition of claim 1 and claim 2 wherein the chocolate component is natural with no artificial flavors or isn't natural and has artificial flavors.

10. The composition of claim 9 wherein the chocolate component is natural with no artificial flavors.

11. The composition of claim 1 and claim 2 wherein the chocolate component has milk fat or has no milk fat or is processed with alkali or isn't processed with alkali.

12. The composition of claim 11 wherein the chocolate component has no milk fat and isn't processed with alkali.

13. The composition of claim 1 and claim 2 wherein the chocolate percentage is 0% to 60%, alternatively 0% to 5%, alternatively 5% to 10%, alternatively 10% to 15%, alternatively 15% to 20%, alternatively 20% to 25%, alternatively 25% to 30%, alternatively 30% to 35%, alternatively 35% to 40%, alternatively 40% to 45%, alternatively 45% to 50%, alternatively 50% to 55%, alternatively 55% to 60%, by weight of said composition.

14. The composition of claim 1 wherein an edible oil component is 0.001% to 15%, alternatively 0% to 5%, alternatively 5% to 10%, alternatively 10% to 15% with a high level of unsaturated fatty acids, by said composition.

15. The composition of claim 14 wherein the edible oil component comes from the group of edible oils including; canola oil, soybean oil, safflower oil, sunflower oil, sesame oil, walnut oil, olive oil, flaxseed oil, chia seed oil, almond oil, corn oil, grape seed oil, peanut oil, other nut oils, or other edible oils with high levels of unsaturated fatty acids, and combinations thereof.

16. The composition of claim 15 wherein the edible oil is a blend of canola, soybean oil, and sunflower oil.

17. The composition of claim 15 wherein the edible oil is a blend of canola, soybean oil, and olive oil.

18. The composition of claim 1 wherein a 100% Cocoa component is 0.001% to 20%, alternatively 0% to 5%, alternatively 5% to 10%, alternatively 10% to 15%, alternatively 15% to 20%, by weight of said composition.

19. The composition of claim 18 wherein a 100% Cocoa powder component comes from the group of defatted 100% Cocoa powder, low fat or 12% fat or less 100% Cocoa powder , fully fatted 100% cocoa powder 12% or higher fat content , and dutched 100% Cocoa powder defatted, low fat 12% fat or less, and fully fatted 12% or higher fat content.

20. The composition of claim 19 wherein the 100% Cocoa powder component has a low fat content of 12% or less.

21. The composition of claim 20 wherein a less than 100% Cocoa powder component is added in place of the 100% Cocoa component that has a low fat content of 12% or less.

22. The composition of claim 1 where the confectionery sugar component is 0.001% to 20%, alternatively 0.001% to 5%, alternatively 5% to 10%, alternatively 10% to 15%, alternatively 15% to 20%, by weight of said composition.

23. The composition of claim 1 wherein a cocoa seed butter crystals component that helps with the chocolate set structure is 0% to 2%, by weight of said composition.

24. The composition of claims 1 and 2 wherein the virgin coconut oil component is 0.001% to 5%, by weight of said composition.

25. The composition of claims 1 and 2 wherein the vanilla powder component is 0.001% to 5%, by weight of said composition.

26. The composition of claims 1 and 2 wherein the blackberry powder is 0.01 to 4%, by weight of said composition.

27. The composition of claim 26 wherein the blackberry powder is replaced with a berry powder from the group including raspberry, black raspberry, and Marion blackberry or a combination of these different berries or a combination of blackberry powder and these different berry powders.

28. The composition of claims 1 and 2 wherein the Acai Berry extract is 0% to 1%, by weight of said composition.

29. The composition of claims 1 and 2 wherein a supplement component is 0% or greater, by weight of said composition.

30. The composition of claim 29 wherein the supplement component comes from the group consisting of: vitamins, minerals, herbs, botanicals, essential fatty acids, seeds, plant derived supplements including sterols and stanols, animal derived supplements, therapeutic compounds, and mixtures thereof; by weight of said composition.

31. The composition of claim 1 wherein certain ratios of ingredients produce an improved health characteristic, higher antioxidant content, lower sugar, excellent taste, texture, and melt non-standardized milk chocolate composition with 25% to 100% less milk fat than regular milk chocolate and that has a milk fat content of 0% to 8%.

32. The composition of claim 1 wherein certain edible oils chosen for the composition are high in unsaturated fat especially polyunsaturated fat including the essential fatty acids Omega 6 linoleic and Omega 3 ALA's alpha-linolenic. These essential fatty acids could come from the following edible oils; canola oil, walnut oil, chia seed oil, flaxseed oil, grape seed oil, or a blend of these oils or other edible oils with high polyunsaturated fat that includes Omega 6 and Omega 3 fats. The composition utilizing these oils with essential fatty acids creates an improved health characteristic, higher antioxidant content, lower sugar, excellent taste, texture, and melt, non-standardized milk chocolate composition with 25% to 100% less milk fat versus regular milk chocolate, that has a milk fat content of 0% to 8%, and that has a better balance between saturated, monounsaturated, and polyunsaturated fats than regular milk chocolate.

33. The composition of claim 1 wherein the addition of a chocolate component, an edible oil component, a 100% cocoa component, a confectionery sugar component, and antioxidant flavor blend component consisting of virgin coconut oil, vanilla powder, blackberry powder, potentially Acai berry extract, and potentially a supplement to a low milk fat 0% to 3.69% chocolate or a standardized milk chocolate with a 3.69% to 8% milk fat creates a non-standardized milk chocolate with up to 50% less sugar than regular milk chocolate.

34. The compositions of claim 31, claim 32, and claim 33 would comprise the following:
a. 40% to 95% a standardized milk chocolate with 3.69% to 8% milk fat or a low milk fat chocolate with less than 3.69% milk fat
b. 0% to 60% a chocolate component
c. 0.001% to 15% edible oil component
d. 0.001% to 20% 100% cocoa powder component
e. 0.001% to 20% confectionery sugar component
f. 0% to 2% cocoa seed butter crystals component
g. 001% to 5% virgin coconut oil component
h. 0.01 to 5% vanilla powder component
i. 0% to 4% blackberry powder component
j. 0% to 1% Acai Berry extract component

35. The composition of claim 34 where a supplement component is added to the composition.

36. The composition of claim 35 where the supplement component is 0% or greater Omega 3 DHA/EPA.

37. The composition of claim 35 where the supplement component is 0% or greater plant sterols, by weight of said composition.

38. The composition of claim 35 where the supplement component are both Omega 3 DHA/EPA at 0% or greater and plant sterols at 0% or greater, by weight of said composition.

39. The composition of claim 2 where certain ratios of ingredients create an improved health characteristic, unique synergistic higher antioxidant content, lower sugar, improved taste, texture, melt, and creaminess standardized milk chocolate composition that has 3.69% milk fat or greater.

40. The composition of claim 39 would comprise the following:
a. 40% to 95% milk chocolate with a milk fat content of 3.69% or higher
b. 0% to 60% a chocolate component
c. 0.001% to 5% virgin coconut oil component
d. 0.001% to 5% vanilla powder component
e. 0.001% to 4% blackberry powder component
f. 0% to 1% Acai Berry Extract component

41. The composition of claim 40 wherein a supplement component at 0% or greater is added to the composition.

42. The composition of claim 41 wherein the supplement component is 0% or greater Omega 3 DHA/EPA, by weight of said composition.

43. The composition of claim 41 wherein the supplement component is 0% or greater plant sterols, by weight of said composition.

44. The composition of claim 41 wherein the supplement component are both Omega 3 DHA/EPA at 0% or greater and plant sterols at 0% or greater, by weight of said composition.

45. The composition of claim 1 and claim 2 wherein said composition comprises a form selected from the group consisting of: bite size pieces, squares or rectangles of specific weight, varying molded shapes or sizes that are available for chocolate confectionery products including bars and larger tablet bars, a coating for a confectionery or food, an enrobing material for confectionery or food, a layering material for a confectionery or food, and an ingredient for a confectionery or food.

46. A method of preparing a composition of claim 34 wherein certain ratios of ingredients create an improved health characteristic, higher antioxidant content, lower sugar, lower milk fat, unique taste profile created by the synergistic antioxidant blend taste profile produces an improved taste, texture, melt, and creaminess non-standardized milk chocolate that can have 25% to 100% less milk fat versus regular milk chocolate comprising the steps of: a. melting the standardized milk chocolate or low milk fat milk chocolate with a milk fat content of 8% to 0% milk fat , the chocolate component if necessary and tempering it in a confectionery melting and tempering machine that can also act as the mixing vessel or then putting the melted and tempered chocolate component into a mixing vessel; b. add 0% to 2% cocoa seed butter crystals component if necessary; c. add 0.001% to 5% vanilla powder component; d. add 0.001% to 4% blackberry powder component; and e. add 0% to 1% Acai Berry Extract component.
In a separate mixing vessel follow these steps; a. add 0.001% to 15% an edible oil component; b. add 0.001% to 20% a 100% cocoa powder component; c. add 0.001% to 20% a confectionery sugar component to the mixing vessel; d. add 0.001% to 5% a virgin coconut component; e. heat and mix the edible oil component, the virgin coconut oil component and confectionery sugar component until homogeneous; f. then blend the 100% cocoa powder component into the mixture and mix until homogeneous; g. add contents of second mixing vessel that include the edible oil component, 100% Cocoa component, confectionery sugar component, and virgin coconut oil component to the first mixing vessel that includes the melted and tempered milk chocolate component, chocolate component if necessary, cocoa seed butter crystals component if necessary, vanilla powder component, blackberry powder component, and Acai berry extract component if necessary; h. blend the final mixture together until completely homogeneous; thus, creating a double blended non-standardized milk chocolate composition that has the above listed characteristics.

47. A method of claim 46 further comprising the step of adding a supplement from the above group listed and adding an additional component selected from the group consisting of a flavor component, a color component, a preservative component, and mixing until the above mixture becomes homogeneous with the additional listed components.

48. A method of preparing a composition of claim 40 wherein certain ratios of ingredients create an improved health characteristic, higher antioxidant content, lower sugar content, unique taste profile created by the synergistic reaction of the antioxidant blend taste profile that produces an improved taste, texture, melt, and creaminess standardized milk chocolate composition comprising the steps of: a. melting the milk chocolate and chocolate if necessary and tempering it in a mixing vessel or then putting it into a mixing vessel; b. add the virgin coconut oil component to the mixing vessel; c. add the vanilla powder component to the mixing vessel; d. add the blackberry powder component to the mixing vessel; e. add the Acai berry extract component if necessary to the mixing vessel and blend until homogeneous; thus, creating a standardized milk chocolate composition that has the above listed characteristics.

49. The method of claim 48 further comprising the step of adding an additional supplement component from the group listed above in claim 30 and adding a component selected from the group consisting of a flavor component, a color component, a preservative component, and mixing until the above mixture becomes homogeneous with the additional listed components.

50. The method of claims 46 and claims 48 further comprising the step of processing said final mixture and using it as a coating, for enrobing, for a layer in a composition bar, for an ingredient in another confectionery or food or via a chocolate molding line into molded squares, other chocolate molded shapes, bars, or tablet bars, chips, chunks or other chocolate confectionery applications. These molded chocolate products would be packaged as standard in the confectionery industry and for example if chocolate bars were produced then the pieces would be flow wrap packaged or envelope wrap packaged or foil and wrapper packaged based on the type of product being created. These wrapped confectionery products would then be packaged in secondary packaging including but not limited to bags or cartons, pop boxes, sleeves, or other chocolate confectionery packaging containers.
